(19) United States
(12) Patent Application Publication
(10) Pub. No.: US 2025/0214719 A1
(43) Pub. Date: Jul. 3, 2025

(54) FLIGHT AND MISSION PLANNING AS A SERVICE

(71) Applicant: R2 Space, LLC, Ann Arbor, MI (US)

(72) Inventors: Nathan Mark Hamet, Washington, DC (US); Zachary Miles Meza, Vienna, VA (US); Shaishav M. Parekh, Richmond, VA (US); Sandilya Balaramakrishna Bhagavathula, Washington, DC (US)

(21) Appl. No.: 17/890,787

(22) Filed: Aug. 18, 2022

Related U.S. Application Data
(60) Provisional application No. 63/237,970, filed on Aug. 27, 2021.
(60) Provisional application No. 63/237,979, filed on Aug. 27, 2021.

(51) Int. Cl. B64G 1/24; B64G 1/10; G01S 13/90

(52) U.S. Cl. CPC B64G 1/242; B64G 1/1035; B64G 1/245

(57) ABSTRACT

Described herein are spacecraft flight and mission managers and systems, methods, and computing apparatuses for dynamically maneuvering a spacecraft towards a target area for synthetic aperture radar (SAR) capture based on antenna availability. In an embodiment, a flight and mission manager obtains user inputs for a spacecraft mission related to a synthetic aperture radar request of a target area and maneuvers for a spacecraft to reach that target area. An orbit path is determined based on user inputs and telemetry of the spacecraft. A visibility schedule of antennas of a ground station provider is obtained corresponding to the orbit path. Then, a tasking plan is generated to perform the user inputs and maintain the orbit path.

### RELATED APPLICATIONS

This application hereby claims the benefit and priority to U.S. Provisional Application No. 63/237,970, titled “FLIGHT AND MISSION PLANNING AS A SERVICE,” filed Aug. 27, 2021, and U.S. Provisional Application No. 63/237,979, titled “FLIGHT AND MISSION PLANNING AS A SERVICE,” filed Aug. 27, 2021, which are hereby incorporated by reference in their entirety.

### TECHNICAL FIELD

Various embodiments of the present technology relate to spacecraft mission orchestration and systems, methods, and devices for tasking, coordinating, and managing spacecraft flight and mission operations.

### BACKGROUND

With a rise in space exploration comes an increase in spacecrafts, satellites, and other objects in orbit around Earth. Satellites, for example, are generally controlled from a mission control station or operate using programmable onboard processors. To monitor for potential collisions or threats with any of the various objects in space, control operators can use satellite telemetry and compare a satellite's orbit with the location of debris and other objects that may be nearby. This may require constant supervision from the control operator to prevent danger and alert satellite owners or users.

To avoid collisions and make maneuvers to reach areas in-orbit, satellites can be controlled by one or more antennas on Earth via wireless communication links. Controlling such satellites from a ground station requires coordinating the satellite with an antenna in-view of the satellite. However, not all ground station providers allow for communication using their equipment without specific interfacing and communication protocols. Further, satellites equipped with imaging systems, such as synthetic aperture radar technology, downlink imaging data to process SAR images. Again, this requires planning to maneuver a satellite to a target area while avoiding conjunctions and finding an appropriate antenna to command the satellite according to an operator's command.

Flight and mission planning applications can provide the ability to interface with a satellite and ground station and monitor flight operations; however, connectivity and automation are limited. In fact, intense supervision in existing solutions is still required. Alerts provided via these systems can be clunky and require human intervention to update satellite orbit plans.

### OVERVIEW

A spacecraft mission manager is disclosed herein that can dynamically maneuver a spacecraft towards a target area for observation, data capture (e.g., synthetic aperture radar (SAR)), and telecommunications, among other functions, based on antenna availability. Orchestration of flight and mission objectives provides at least one or more benefits such as improved connectivity to ground station providers, autonomous management of orbit plans and collision avoidance, and customizability and modularity of spacecraft flight management systems.

In an embodiment, a method of operating a spacecraft mission manager is provided. The method comprises obtaining user inputs for a spacecraft mission, wherein the user inputs comprise at least a synthetic aperture radar request of a target area and one or more maneuvers for a spacecraft to reach the target area. The method further comprises determining an orbit path of the spacecraft based at least on the user inputs and telemetry of the spacecraft and obtaining a visibility schedule of one or more antennas from one or more ground station providers corresponding to the orbit path of the spacecraft. Then, the method comprises generating a tasking plan to perform the user inputs for the spacecraft mission based at least on the visibility schedule and providing the tasking plan to at least one ground station provider of the one or more ground station providers.

This Overview is provided to introduce a selection of concepts in a simplified form that are further described below in the Detailed Description. This Overview is not intended to identify key features or essential features of the claimed subject matter, nor is it intended to be used as an aid in determining the scope of the claimed subject matter.

While multiple embodiments are disclosed, still other embodiments of the present technology will become apparent to those skilled in the art from the following detailed description, which shows and describes illustrative embodiments of the invention. As will be realized, the technology is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present technology will be described and explained through the use of the accompanying drawings in which:

FIG. 1 illustrates an exemplary operating architecture that can be used to implement spacecraft mission orchestration processes in which some embodiments of the present technology may be utilized;

FIGS. 2A, 2B, and 2C are flowcharts illustrating a series of steps for orchestrating spacecraft mission and flight plans in accordance with some embodiments of the present technology;

FIG. 3 illustrates an exemplary operating environment that models interfacing between users and ground station providers in accordance with some embodiments of the present technology;

FIG. 4 illustrates an exemplary operating architecture of a flight management system in which some embodiments of the present technology may be utilized;

FIG. 5 illustrates an exemplary operating architecture of a mission plan management system in which some embodiments of the present technology may be utilized;

FIG. 6 illustrates an exemplary operating architecture of a scheduling orchestrator interfaced with ground station providers in which some embodiments of the present technology may be utilized;

FIG. 7 is a sequence diagram illustrating data flow between various components of a spacecraft mission orchestration system in accordance with some embodiments of the present technology;

FIG. 8 is a flowchart illustrating a series of steps for prioritizing and deconflicting spacecraft mission tasks in accordance with some embodiments of the present technology;

FIG. 9 illustrates an exemplary operating architecture of development and production environments which may be utilized in some embodiments of the present technology; and

FIG. 10 illustrates a computing device that may be used in accordance with some embodiments of the present technology.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology relate to spacecraft mission planning and orchestration. More specifically, embodiments relate to spacecraft flight and mission managers and systems, methods, and computing apparatuses for dynamically maneuvering a spacecraft towards a target area for observation, data capture (e.g., synthetic aperture radar (SAR)), and telecommunications, among other functions, based on antenna availability. In an embodiment, a method for operating a flight and mission manager is provided. The method comprises obtaining user inputs for a spacecraft mission, wherein the user inputs comprise at least a synthetic aperture radar request of a target area and one or more maneuvers for a spacecraft to reach the target area. The method further comprises determining an orbit path of the spacecraft based at least on the user inputs and telemetry of the spacecraft and obtaining a visibility schedule of one or more antennas from one or more ground station providers corresponding to the orbit path of the spacecraft. Then, the method comprises generating a tasking plan to perform the user inputs for the spacecraft mission based at least on the visibility schedule and providing the tasking plan to at least one ground station provider of the one or more ground station providers.

Another embodiment provides for a computing apparatus comprising one or more computer-readable storage media and program instructions stored on the one or more computer-readable storage media that, based on being read and executed by a processing system, direct a spacecraft mission manager to perform various functions. The program instructions direct the spacecraft mission manager to at least obtain user inputs for a spacecraft mission, wherein the user inputs comprise at least a synthetic aperture radar request of a target area and one or more maneuvers for a spacecraft to reach the target area. The program instructions further direct the spacecraft mission manager to determine an orbit path of the spacecraft based at least on the user inputs and telemetry of the spacecraft and obtain a visibility schedule of one or more antennas from one or more ground station providers corresponding to the orbit path of the spacecraft. The program instructions also direct the spacecraft mission manager to generate a tasking plan to perform the user inputs for the spacecraft mission based at least on the visibility schedule and provide the tasking plan to at least one ground station provider of the one or more ground station providers.

In yet another embodiment a method of operating a spacecraft mission manager is provided. The method comprises obtaining a collection request comprising one or more tasks for a spacecraft to perform synthetic aperture radar capture of a target area, obtaining a visibility schedule of one or more ground station providers, wherein the visibility schedule provides one or more timeframes of availability of at least one ground station provider of the one or more ground station providers based at least on the collection request and telemetry of the spacecraft, prioritizing the one of more tasks based at least on conflict criteria and the visibility schedule of the one or more ground station providers, and generating a spacecraft mission plan based at least on the prioritized one or more tasks.

In an embodiment, another method for operating a spacecraft flight manager is provided. The method comprises obtaining telemetry of a spacecraft to determine an orbit path of the spacecraft, obtaining a conjunction assessment corresponding to the orbit path of the spacecraft, wherein the conjunction assessment provides telemetry of objects in the orbit path, setting one or more thresholds corresponding to the conjunction assessment and the orbit path of the spacecraft, and, responsive to a breach of at least one threshold of the one or more thresholds, providing a notification of the breach.

A further embodiment provides for a computing apparatus comprising one or more computer-readable storage media and program instructions stored on the one or more computer-readable storage media that, based on being read and executed by a processing system, direct a spacecraft flight manager to perform various functions. The program instructions direct the spacecraft flight manager to at least obtain telemetry of a spacecraft to determine an orbit path of the spacecraft. The program instructions further direct the spacecraft flight manager to obtain a conjunction assessment corresponding to the orbit path of the spacecraft, wherein the conjunction assessment provides telemetry of objects in the orbit path. The program instructions also direct the spacecraft flight manager to set one or more thresholds corresponding to the conjunction assessment and the orbit path of the spacecraft, and, responsive to a breach of at least one threshold of the one or more thresholds, provide a notification of the breach.

In another exemplary embodiment, one or more computer-readable storage media having program instructions stored thereon to operate a spacecraft mission orchestration engine is provided. In this embodiment, the program instructions, when read and executed by a processing system, direct the processing system to at least obtain user inputs for a spacecraft mission, wherein the user inputs comprise at least a synthetic aperture radar request of a target area and one or more maneuvers for a spacecraft to reach the target area, determine an orbit path of the spacecraft based at least on the user inputs and telemetry of the spacecraft, obtain a visibility schedule of one or more antennas from one or more ground station providers corresponding to the orbit path of the spacecraft, generate a tasking plan to perform the user inputs for the spacecraft mission based at least on the visibility schedule, and provide the tasking plan to at least one ground station provider of the one or more ground station providers.

Advantageously, a spacecraft mission manager can intake several user commands for SAR capture requests, spacecraft maneuvers, and the like and prioritize them based on spacecraft constraints and ground station availability, among other factors. This not only provides the ability to control spacecraft(s) based on customer needs, but also improves connectivity with multiple ground station providers to ensure an efficient antenna is utilized to carry out capture requests.

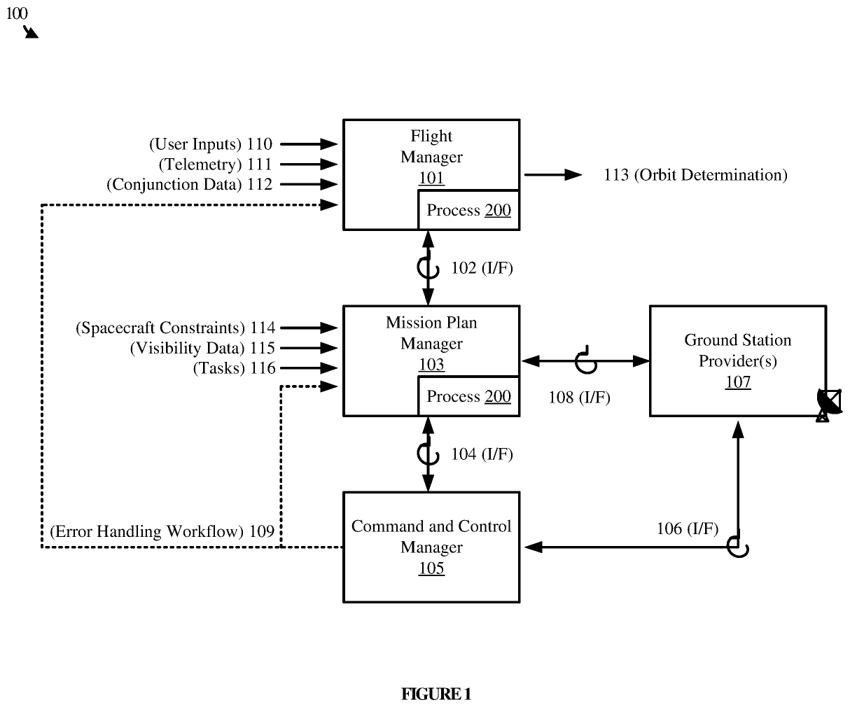

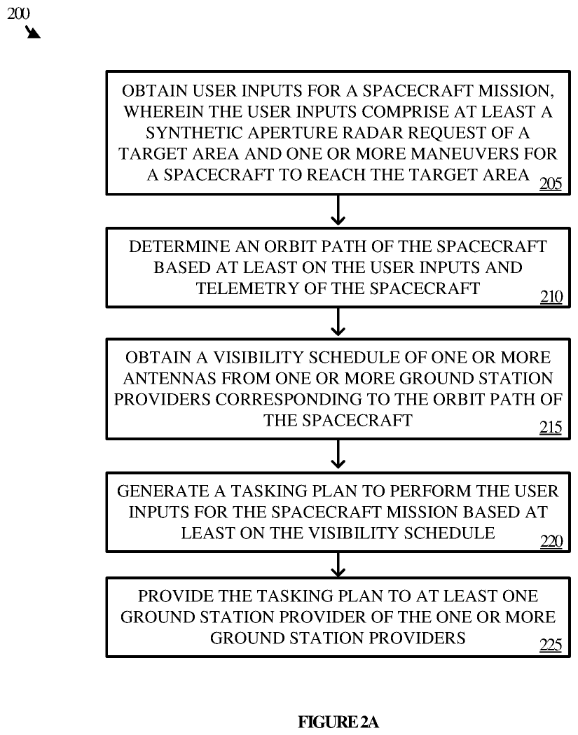

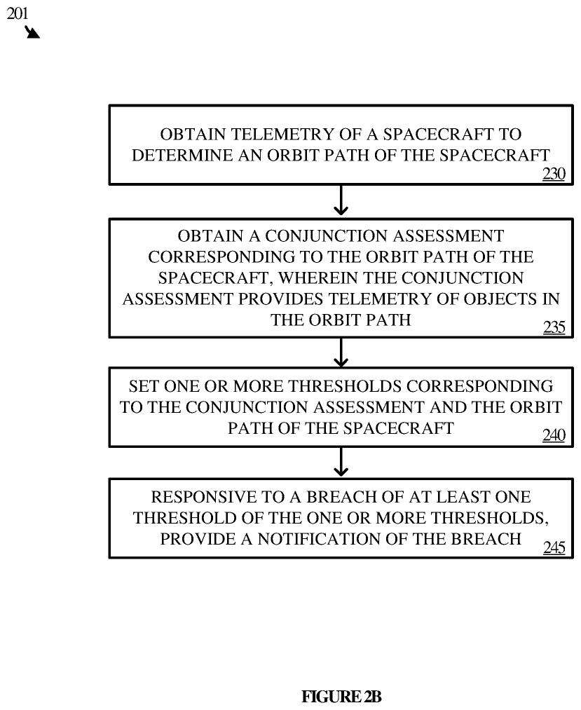

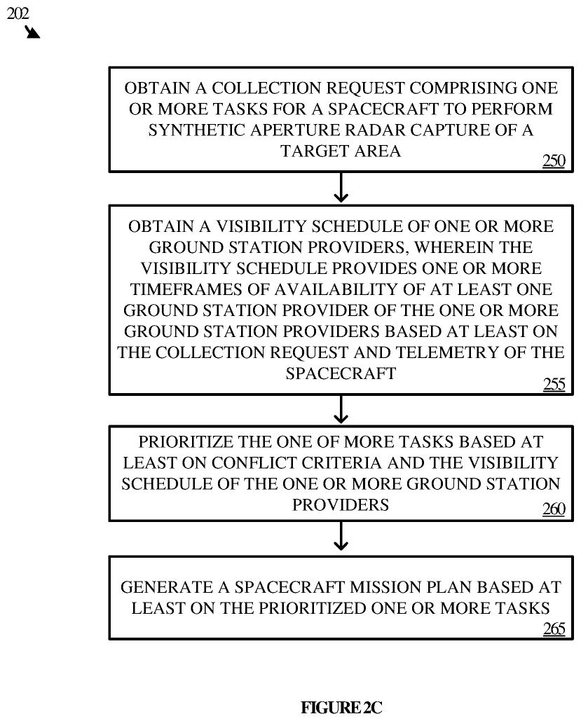

Turning now to the Figures, FIG. 1 illustrates an exemplary operating architecture that can be used to implement spacecraft mission orchestration processes in which some embodiments of the present technology may be utilized. FIG. 1 includes operating architecture 100, which further includes flight manager 101, mission plan manager 103, command and control manager 105, and ground station provider 107. Flight manager 101 receives, as inputs, user inputs 110, telemetry 111, and conjunction data 112, while providing orbit determination 113 as an output. Mission plan manager 103 receives, as inputs, spacecraft constraints 114, visibility data 115, and tasks 116. Both flight manager 101 and mission plan manager 103 can execute process 200 of FIG. 2 on software, hardware, firmware, or any combination thereof to run spacecraft mission planning processes.

In operation, the elements of operating architecture 100 function together to coordinate flight of a spacecraft, such as a satellite equipped with synthetic aperture radar (SAR) technology, plan and prioritize user-defined tasks, communicate with ground station providers to secure antenna scheduling, and command the spacecraft to operate accordingly. Beginning with flight manager 101, flight manager 101 receives or obtains various inputs to perform flight coordination and orbit determination. The inputs include, but are not limited to user inputs 110, telemetry 111, and conjunction data 112. Each input can be provided from one or more remote or local databases via a wireless communication link. User inputs 110 comprise information such as a customer profile, mission profile, user-defined tasks and/or maneuvers, and the like. A customer profile can include a customer name, satellite information and constraints, and the like. A mission profile can include mission-specific information such as satellite characteristics, mission management style (e.g., pass cadence), tasks, antenna or ground station provider information and location, and more. Telemetry 111 comprises global positioning system (GPS) data, attitude data, such as from an attitude determination and control subsystem (ADCS), position, velocity, and time measurements, and the like. Alternatively, telemetry 111 can comprise ranging data (e.g., doppler data) for propagating an estimated orbit. Conjunction data 112 comprises satellite or space object ephemeris that tracks objects in Earth orbit to provide determinations of possible conjunctions while enroute to a target area during mission operations.

Using the various aforementioned inputs, flight manager 101 can determine where the spacecraft is, where it is going, and how it will get there. To accomplish orbit determinations, flight manager 101 can process telemetry 111 to estimate a current spacecraft state (i.e., position, time, velocity, coefficient of drag). Then, flight manager 101 can propagate the spacecraft state into the future to create a predictive ephemeris for the spacecraft. Flight manager 101 can take user inputs 110 and telemetry 111, among other factors, into account during orbit propagation to determine an estimate of the spacecraft's future orbit and attitude, or a two-line element (TLE). Further, flight manager 101 can ingest conjunction data 112, which provides insight on other objects in-orbit or near the spacecraft's orbit that might cause a collision without avoidance maneuvers in place. Flight manager 101 can provide a current and future-looking ephemeris, such as orbit determination 113, with covariance for downstream use by flight operators or other users. For example, the orbit determination 113 can be provided to the 18th Space Control Squadron (18SPCS) to compare the spacecraft's projected orbit (e.g., TLE) with conjunction data 112. Either flight manager 101 or 18SPCS, for example, can determine whether a maneuver is required based on conjunction data 112. In some embodiments, flight manager 101 can also provide orbit determination 113 to a user or control operator.

Additionally, flight manager 101 can determine a position and time that the spacecraft can communicate with one or more antennas or ground stations on/near Earth based at least on orbit determination 113 and locations of each antenna or ground station. For example, flight manager 101 can predict a range and/or duration that the spacecraft may be in view of an antenna. Ground station provider(s) 107 can use the spacecraft's TLE to generate a visibility schedule according to the windows of availability. The visibilities can provide one or more timeframes for communication, data capture, and the like. Flight manager 101 then provides various outputs to mission plan manager 103 via an interface 102. Interface 102 can be a wired or wireless communication interface, or any other type of interface to transfer information.

Mission plan manager 103 receives inputs such as spacecraft constraints 114, visibility data 115, and tasks 116 from flight manager 101, a user device, or elsewhere to execute process 200. Spacecraft constraints 114 can include power constraints of the vehicle, processing capacity, health information, and the like. Visibility data 115 can include the visibility schedule provided by flight manager 101. Tasks 116 can include manually added or automatically generated tasks based on mission objectives. For example, tasks 116 can include spacecraft maneuvers for collision avoidance (manually or automatically input by a user and/or flight manager 101), to reach a particular antenna or ground station provider, to reach a target area on or near Earth, and the like. Further, tasks 116 can also include collection requests, such as SAR data captures by the spacecraft, among other radar-based activities. The collection requests may indicate an area of interest or target area. In some embodiments, mission plan manager 103 and/or flight manager 101 can evaluate the collection request by determining if the spacecraft can feasibly reach the area of interest given its orbit path. In another embodiment, flight manager 101 can determine when the spacecraft may be in view of an area of interest, and the quality of a collection obtainable at the area of interest.

Mission plan manager 103 can comprise a capacity planner, a task organizer, and other applications to coordinate spacecraft tasking with the current and predictive ephemeris calculated by flight manager 101. For example, the capacity planner can manage the spacecraft constraints 114, tasks 116, and user inputs 110 of flight manager 101, among other inputs, to determine what the spacecraft can accomplish during each pass. The capacity planner can provide information to the task organizer to prioritize spacecraft tasks. The task organizer can deconflict coinciding tasks, override tasks (e.g., if emergency maneuver required to avoid conjunction), and reorganize tasks in a queue. Based at least on the queue of prioritized tasks and the visibility data 115, mission plan manager 103 can communicate with one or more ground station providers 107 via interface 108 to reserve one or more antennas to carry out tasks 116 at specific times. In some embodiments, mission plan manager 103 can reserve antennas from several of ground station providers 107 to carry out tasks 116 throughout a pass during orbit. To reserve an antenna from ground station providers 107, mission plan manager 103 may request one or more contacts from ground station providers 107 for tasking, communicating, and/or downlinking, among other functions. For example, one antenna can be reserved to signal a single task during orbit, and another antenna can be reserved to signal a different task later in orbit. Mission plan manager 103 may reserve certain antennas based on criteria. The criteria can include cost of use, resolution or quality of the antenna, duration of availability, security of antenna, and the like.

Next, mission plan manager 103 can communicate a tasking plan to command and control manager 105 via an interface 104. Command and control manager 105 communicates with the one or more ground station providers 107 via interface 106 to command the spacecraft via the reserved antenna(s). The ground station providers 107 can be ground segment as a service companies, like AWS, Microsoft, Atlas, and KSAT configured to use their antennas to communicate with spacecrafts. Additionally, each of ground station providers 107 can obtain telemetry 111 of the spacecraft and/or a ground station provider and pass on the data to command and control manager 105 to perform data analytics on the tasking plan and outcomes. In other embodiments, ground station providers 107 can provide doppler data to predict where the spacecraft is.

In task failure scenarios whereby a task communicated by command and control manager 105 cannot or is not executed by the spacecraft, command and control manager 105 utilizes an error handling workflow 109 to replan or retry the mission and task planning. Command and control manager 105 can communicate with both or either flight manager 101 and/or mission plan manager 103 to re-execute the tasking plan. For instance, error handling workflow 109 can trigger flight manager 101 to re-evaluate orbit determination 113 after the spacecraft missed a task or collection request due to a required maneuver. In another instance, error handling workflow 109 can trigger mission plan manager 103 to reserve another ground station provider 107 and/or re-prioritize tasks accordingly after spacecraft misses a task. Thus, regardless of an error, operating architecture 100 can perform to coordinate the flight and mission planning of a spacecraft.

FIGS. 2A, 2B, and 2C are flowcharts illustrating a series of steps for orchestrating spacecraft mission and flight plans in accordance with some embodiments of the present technology. FIGS. 2A, 2B, and 2C include processes 200, 201, and 202, respectively, each operation noted parenthetically in the discussion below and which reference elements of FIG. 1. It may be appreciated that each process can be implemented on software, hardware, firmware, or any combination thereof. For example, process 200 can be executed on or by flight manager 101 of FIG. 1. Process 200 can also be executed on or by mission plan manager 103 of FIG. 1. Alternatively, process 201 can be executed on or by flight manager 101 of FIG. 1, and process 202 can be executed on or by mission plan manager 103 of FIG. 1.

Beginning with process 200, in operation 205, a flight manager 101 obtains (205) user inputs for a spacecraft mission, wherein the user inputs comprise at least a synthetic aperture radar (SAR) request of a target area by a spacecraft and one or more maneuvers to reach the target area. The SAR request may identify a location on or near Earth and capabilities of the spacecraft in completing the SAR request, such as processing capacity, range, and the like.

In operation 210, a flight manager 101 determines (210) an orbit path of the spacecraft based at least on the user inputs and telemetry of the spacecraft. The telemetry can provide a position, velocity, time, and other measurements of the spacecraft so the flight manager 101 can locate the spacecraft in orbit. The user inputs include maneuvers or tasks for the spacecraft to complete to reach the target area, and thus can be used to propagate a future orbit path of the spacecraft. Flight manager 101 can also use the telemetry to determine whether the spacecraft is at risk of a collision with debris or other objects in space. If so, flight manager 101 can enable maneuvers to avoid the collision.

Next, in operation 215, flight manager 101 obtains (215) a visibility schedule for one or more antennas of one or more ground station providers corresponding to the orbit path of the spacecraft. Flight manager 101 can communicate with the one or more ground station providers to determine availability of their antenna(s). Accordingly, flight manager 101 can use the orbit path to determine if/when the spacecraft may be in view of the antenna(s) and utilize its communication. The visibility schedule can provide timeframes and/or durations of availability for the one or more antennas at each ground station provider. In some instances, zero or one antennas may be available for use during a window of time; however, in other instances, multiple antennas may be available, which can allow mission plan manager 103 to decide which antenna(s) to use for specific tasks.

In operation 220, mission plan manager 103 generates (220) a tasking plan to perform the user inputs for the spacecraft mission based at least on the visibility schedule. Flight manager 101 and/or mission plan manager 103 can receive various maneuvers, tasks, and the like that can alter the mission of the spacecraft. Mission plan manager 103, however, can organize and prioritize a tasking plan to ensure that proper maneuvers are made to avoid collisions while in orbit to perform the tasks assigned to the spacecraft, such as capturing a SAR image of a target area on Earth. Mission plan manager 103 can prioritize tasks based on several criteria, which may include but is not limited to cost of the task, duration in the queue, customer priority and importance, antenna or ground station desired, and the like. After determining the order of the tasking plan, mission plan manager 103 can plan the tasks according to the visibility schedule to ensure that tasks can be completed, where (in-orbit) they can be completed, at what time, and by which ground station provider. By way of example, a customer may input a task that requires significant processing power over a long duration of time compared to an existing task in the queue. In another example, the customer's task may take too long to complete for various reasons, such as insufficient charge/battery power, insufficient visibility with the antenna of a ground station, or the like. In such cases, mission plan manager 103 may determine that an upcoming visibility with a ground provider offers too short of a window to complete the newly added task, so it can rearrange that task per the visibility schedule.

In operation 225, command and control manager 105 provides (225) the tasking plan to at least one ground station provider of the one or more ground station providers. Command and control manager 105, and other components, can communicate with the ground station providers via a wireless communication link, such as an application programming interface (API). In an instance, command and control manager 105 can transmit one or more tasks associated with an antenna to its ground station provider once in view of the ground station provider. In a later instance, command and control manager 105 can send other tasks in the tasking plan assigned to a different antenna and ground station provider to the different ground station provider. Upon receiving the one or more tasks, the ground station provider(s) can uplink the tasks to the spacecraft so it can perform the requests. Further, the ground station provider(s) can receive telemetry data and/or analytics from the spacecraft and/or ground station provider to pass on to command and control manager 105.

FIG. 2B provides a similar series of steps for operating flight manager 101 in various embodiments. In operation 230 of process 201, flight manager 101 obtains (230) telemetry of a spacecraft to determine an orbit path of the spacecraft. The telemetry of the spacecraft can be utilized to determine a current position, velocity, and time, among other measurements, of the spacecraft, while it can also be used to predict the spacecraft's orbit. Flight manager 101 can utilize telemetry of the spacecraft and/or ground station provider to propagate the spacecraft's orbit, such as by analyzing the orbit type or ranging of the spacecraft. In some instances, flight manager 101 provides a predictive ephemeris to a space control user, such as 18SPCS, to assess collision risk in the future. Telemetry can be obtained from a database via a communication link. In other instances, the telemetry can be provided from the spacecraft or another satellite that can provide GPS data. In yet another instance, telemetry can be calculated using doppler data from a ground station provider to predict where the spacecraft is.

Next, in operation 235, the flight manager 101 obtains (235) a conjunction assessment corresponding to the orbit path of the spacecraft, wherein the conjunction assessment provides the telemetry of objects in the orbit path. The conjunction assessment comprises one or more objects, debris, spacecrafts, and the like that exist in space, whether in the same orbit or near the spacecraft's orbit along with a probability or risk of impact. Flight manager 101 can use the conjunction assessment to alter its predicted orbit path accordingly if the conjunction assessment indicates a high level of risk, for example.

In operation 240, the flight manager 101 sets (240) one or more thresholds corresponding to the spacecraft conjunction assessment and the orbit path of the spacecraft. For example, flight manager 101 can set a probability of collision percentage, a distance to potential impact, or the like as thresholds for a space control user or other user to be aware of possible dangers. Thresholds can be set automatically for a given customer or user, or they can be input manually based on a level of risk acceptable by a customer or user.

Lastly, in operation 245, the flight manager 101, responsive to a breach of at least one threshold of the one or more thresholds, provides (245) a notification of the breach. In various embodiments, flight manager 101 can transmit a notification of a breach via e-mail, SMS, telephonic, or other electronic alert to alert a user or computing device (e.g., a space control user, a spacecraft operator, a customer) to take action due to the breach of the threshold. The alert may comprise various pieces of information about the spacecraft, potential threat, orbit path, time to collision, and the like. In some embodiments, the user can maneuver the spacecraft to avoid the threat. In other embodiments, flight manager 101 can determine one or more avoidance maneuvers. It may be appreciated that after one or more maneuvers are made that alter the propagated orbit plan, process 201 can re-run to continuously provide current and predictive ephemeris.

FIG. 2C provides another similar series of steps for operating mission plan manager 103 in various embodiments. Beginning with operation 250, a mission plan manager 103 obtains (250) a collection request comprising at least one or more tasks for a spacecraft to perform synthetic aperture radar capture of a target area. The collection request can indicate a target area and its location, an antenna and/or ground station provider to utilize, the antenna and/or ground station provider's location, a number of images or duration of SAR capture requested, and maneuvers to reach the targeted area, among other tasks.

Responsive to receiving the collection request, mission plan manager 103 obtains (255) a visibility schedule of one or more ground station providers, wherein the visibility schedule provides one or more timeframes of availability of at least one ground station provider of the one or more ground station providers based at least on the collection request and telemetry of the spacecraft. Mission plan manager 103 can communicate with the one or more ground station providers via an API. The ground station provider can indicate whether its antenna(s) are available for transmission, and it can provide timeframes and duration of availability, cost of transmission, resolution, and the like to mission plan manager 103. In some instances, mission plan manager 103 can communicate the collection request to receive specific availability for that request. In other instances, mission plan manager 103 can request availability from the ground station provider irrespective of the collection request.

Next, in operation 260, mission plan manager 103 prioritizes (260) the one or more spacecraft tasks based on at least conflict criteria and the visibility schedule of the one or more ground station providers. The conflict criteria to deconflict the spacecraft tasks can include but is not limited to a determination of the type of tasks requested, a time/date requested, a cost and/or value of the tasks, a source of the tasks, a duration of time in the queue, and the like. For example, mission plan manager 103 may prioritize a customer task over an internal task. For example, mission plan manager 103 can determine that a task fits the visibility schedule, while another task may be too complex or long to complete given the availability of an antenna.

After prioritizing each task of the one or more spacecraft tasks, mission plan manager 103 generates (265) a spacecraft mission plan based at least on the prioritized one or more spacecraft tasks. The spacecraft mission plan can indicate the collection request, an antenna and/or ground station provider to be used, maneuvers required to reach the targeted area and/or the antenna and/or ground station provider, and more. Mission plan manager 103 can provide the spacecraft mission plan to command and control manager 105 or it can communicate the plan directly to the ground station provider for transmission to the spacecraft.

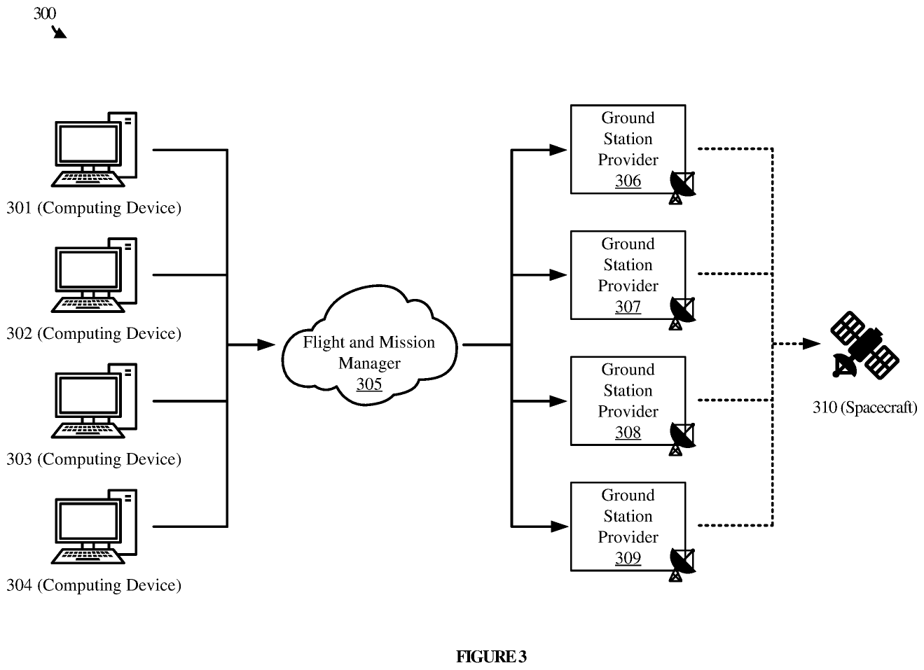

Moving to FIG. 3, FIG. 3 illustrates an exemplary operating environment that models one or more interfaces between users and ground station providers in accordance with some embodiments of the present technology. FIG. 3 includes operating environment 300, which further includes computing devices 301, 302, 303, and 304, each of which communicate with flight and mission manager 305. For example, flight and mission manager 305 can orchestrate spacecraft mission plans by utilizing operating architecture 100 of FIG. 1 or any other operating architecture. Further, flight and mission manager 305 can execute process 200 of FIG. 2. Flight and mission manager 305 communicates with one or more of ground station providers 306, 307, 308, and 309, who ultimately communicate with a spacecraft 310 to operate the mission plans.

Each computing device of computing devices 301, 302, 303, and 304 can represent a user that can interact with flight and mission manager 305 to command and control spacecraft 310 operations. Each computing device can be a computer, tablet, phone, or other device capable of providing inputs to flight and mission manager 305. The computing devices can communicate with flight and mission manager 305 over a wired or wireless communication protocol, such as an API or other interface.

In an embodiment, computing device 301 can represent a customer requesting SAR collection by spacecraft 310. Computing device 301 can provide inputs such as a customer profile, a mission profile, one or more maneuvers, the SAR collection request including a target area and capture information, and more. The customer profile may indicate spacecraft 310 constraints, such as processing capacity, technological ability, power constraints, and the like. The mission profile may indicate customer preferences like pass cadence, ground station providers usable or desired, and the like. The one or more maneuvers can include moves required or desired to reach the target area as part of the SAR collection request. Flight and mission manager 305 can use the inputs to determine an orbit path of spacecraft 310 and direct spacecraft 310 to a ground station provider and/or target area. Flight and mission manager 305 can also determine valid maneuvers, ground station provider availability, conflicting tasks from another computing device, such as computing devices 302, 303, and/or 304, and the like. Flight and mission manager 305 may prioritize or re-prioritize tasks accordingly and notify computing device 301 upon determination of an issue or collection miss, for example. Upon reaching the target area, flight and mission manager 305 can provide the task(s) to an available ground station provider, such as ground station provider 306 via a communication link (e.g., API). Ground station provider 306 can then upload the task(s) and other information to spacecraft 310 to execute the request. Ground station provider 306 can communicate with spacecraft 310 in the X-band frequency range, the S-band frequency range, or some other frequency range or wireless communication protocol.

In another embodiment, computing device 301 can represent a customer requesting SAR collection and computing device 302 can represent a space control user tasked with monitoring the orbit path of spacecraft 310. As flight and mission manager 305 propagates the orbit path of spacecraft 310, the telemetry of spacecraft 310 can be communicated to computing device 302 to compare with the ephemeris of other spacecrafts and objects in or near the orbit path. Computing device 302 can determine potential risks with the flight path of spacecraft 310 and alert computing device 301 and/or flight and mission manager 305 of the risk. Accordingly, either computing device 301 and/or flight and mission manager 305 can modify the orbit of spacecraft 310 to avoid a collision.

It may be appreciated that the above scenarios and others not mentioned can be accomplished using any computing device, ground station provider, or any combination thereof. Further, the components of operating environment 300 may be modular to allow control of one or more spacecrafts to allow for a global cadence of more than one spacecraft.

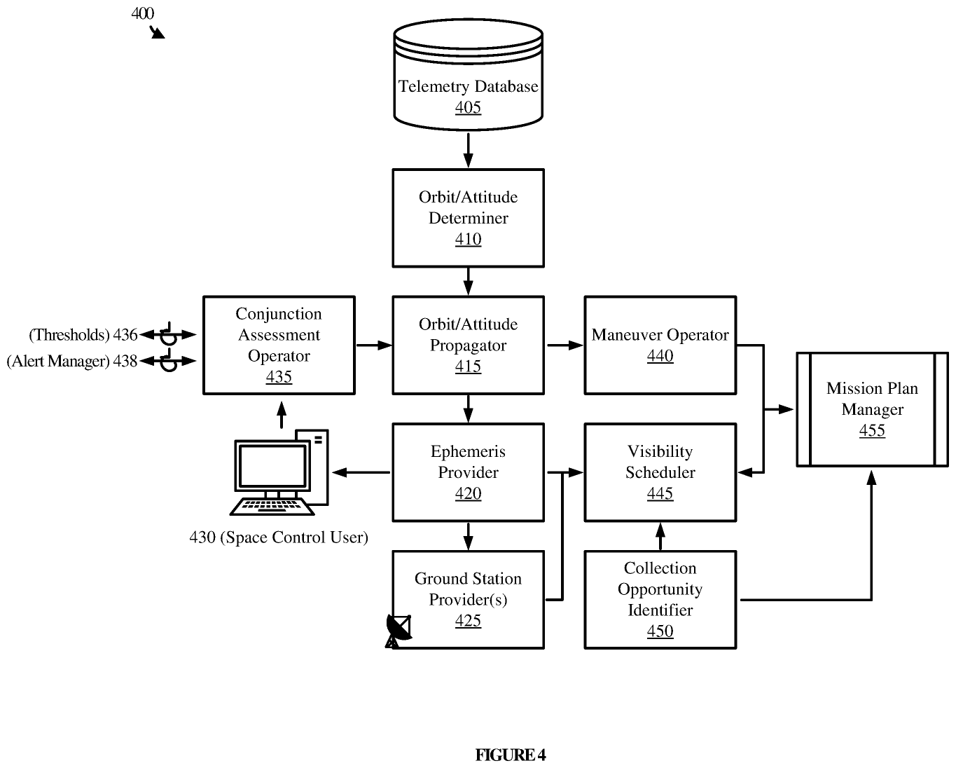

FIG. 4 illustrates an exemplary operating architecture of a flight management system in which some embodiments of the present technology may be utilized. FIG. 4 includes operating architecture 400, which further includes telemetry database 405, orbit/attitude determiner 410, orbit/attitude propagator 415, ephemeris provider 420, ground station provider 425, space control user 430, conjunction assessment operator 435, maneuver operator 440, visibility scheduler 445, collection opportunity identifier 450, and mission plan manager 455. Conjunction assessment operator further receives inputs of thresholds 436 and alert manager 438.

In operation, orbit/attitude determiner 410 obtains telemetry of a spacecraft in orbit from telemetry database 405. Telemetry database 405 can be a local or remote computer-readable storage media configured to store telemetry data, such as position, time, velocity, and other coefficients with respect to one or more spacecrafts. Orbit/attitude determiner 410 can use the telemetry to track a spacecraft's current flight path based on measurements of the spacecraft state. The telemetry may comprise GPS data or it can indicate an orbit type to determining ranging parameters of the orbit. Orbit/attitude determiner 410 can provide the current orbit to orbit/attitude propagator 415 to estimate, with a degree of uncertainty, the spacecraft's orbit in the future.

Ephemeris provider 420 can compile the orbit data, calculate a covariance of the orbit data, and generate a two-line element (TLE) of the spacecraft to indicate where the spacecraft is and where it may be going. Ephemeris provider 420 communicates the estimated orbit data to one or more of ground station provider(s) 425 and space control user 430. More specifically, ephemeris provider 420 may provide the TLE to the one or more ground station providers 425 to obtain a visibility schedule of the provider's antenna(s). Concurrently, ephemeris provider 420 can communicate the ephemeris with covariance to the space control user 430.

The space control user 430 receives the ephemeris with covariance from ephemeris provider 420 to compare the projected spacecraft orbit with ephemeris of other objects in or near orbit. In an instance that space control user 430 identifies a potential risk, space control user 430 communicates with conjunction assessment operator 435 to identify the possible conjunction. Conjunction assessment operator 435 can store one or more thresholds 436 to compare orbit data of the spacecraft and the possible conjunction identified by space control user 430. Thresholds 436 can define limits of acceptable risk. If conjunction assessment operator 435 determines that the possible conjunction breaches one of the thresholds 436, it can trigger alert manager 438 to notify a user of the conjunction. Alert manager 438 can provide a textual message, visual or graphical message, or any combination thereof to relay the information to a customer or other user. Upon receiving an alert, a user or conjunction assessment operator 435 can update the maneuvers of the spacecraft, which can be sent to orbit/attitude propagator 415 to update the predictive ephemeris. Then, orbit/attitude propagator 415 can communicate the requested maneuvers to maneuver operator 440. In other embodiments, a user or conjunction assessment operator 435 can accept/approve a proposed plan for a spacecraft.

Ground station provider(s) 425 can use the predictive ephemeris to provide availability of one or more antennas that can be used to communicate with the spacecraft at a given point during orbit. Ground station provider(s) 425 can provide such availability to visibility scheduler 445 to generate a schedule or timeframe of the one or more antennas. Visibility scheduler 445 can use the ground station schedule to compare availability with incoming collection requests provided by collection opportunity identifier 450. The collection requests can indicate a target area and capture, such as a SAR image capture, to be performed by the spacecraft during orbit. The collection request, visibility schedule, and maneuvers required by the spacecraft can be communicated to mission plan manager 455 to coordinate responsibilities.

It may be appreciated that a change in orbit due to a conjunction assessment, requested maneuver, requested collection opportunity, or other alteration to flight plans can result in a different orbit and availability of ground station providers. As a result, maneuver operator 440 or another element of operating architecture 400 can update the mission plan accordingly.

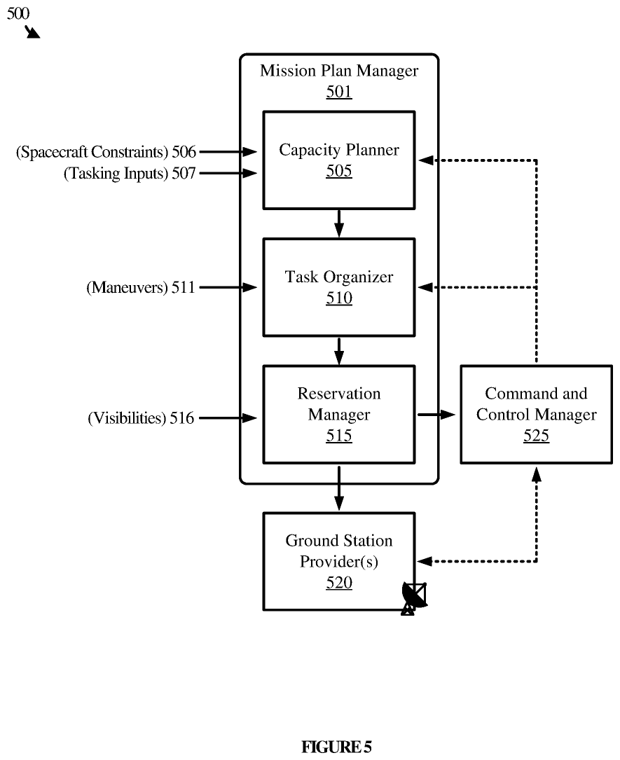

FIG. 5 illustrates an exemplary operating architecture of a mission plan management system in which some embodiments of the present technology may be utilized. FIG. 5 includes operating architecture 500, which further includes mission plan manager 501, ground station provider(s) 520, and command and control manager 525. Mission plan manager 501 comprises capacity planner 505, task organizer 510, and reservation manager 515. Mission plan manager 501 receives inputs such as spacecraft constraints 506, tasking inputs 507, maneuvers 511, and visibilities 516. For example, mission plan manager 501 can execute process 200 or 202 of FIG. 2. Mission plan manager 501 may also be depicted as mission plan manager 455 and receive similar inputs as illustrated in FIG. 4.

In operation, mission plan manager 501 comprises capacity planner 505, task organizer 510, and reservation manager 515, which function together to plan the operations of a spacecraft. Capacity planner 505 can receive spacecraft constraints 506 and tasking inputs 507 from a user, flight planner, or other computing device or application. Spacecraft constraints 506 can include information about the spacecraft, such as power capacity, processing capacity, equipment onboard the spacecraft, spacecraft health, and the like. Tasking inputs 507 can include user-defined inputs like spacecraft maneuvers, collection requests, and the like, and/or automatically-created maneuvers by a flight planner. Capacity planner 505 can be configured to determine whether the spacecraft can process the requested job(s), and at what time during the mission it can process them.

Task organizer 510 can receive maneuvers 511, either requested by a user or generated automatically by a flight planner, and constraints determined by capacity planner 505. Task organizer 510 can evaluate each task in a queue to determine a priority and plan for accomplishing the tasks and maneuvers required of the spacecraft. For example, task organizer 510 can use evaluation criteria such as the cost of the task, source of task, date of service of the task, duration of existence in the task queue, and more. As a result, task organizer 510 can deconflict tasks and provide an organized priority of tasks to reservation manager 515.

Reservation manager 515 receives visibilities 516 from ground station provider(s) 520, flight planner, or other computing device or application. Visibilities 516 indicate an availability of a ground station provider 520 and accompanying antenna(s). For example, visibilities 516 can provide a schedule indicating a date and time that the antenna can be rented or used by the mission plan manager 501 for communication with the spacecraft. Reservation manager 515 can use the prioritized task list from task organizer 510 to reserve timeslots at the ground station provider 520 and allocate time for each task accordingly. Further, reservation manager 515 may determine blackout times of antennas, such as when an antenna is unavailable due to maintenance or some other issue. Reservation manager 515 may communicate with ground station provider(s) 520 via an API or other communication interface.

Reservation manager 515 can then communicate the planned tasking schedule to command and control manager 525. Command and control manager 525 can upload or transmit the tasks to ground station provider(s) 520 via the API. The ground station provider(s) uplink and send the mission plan comprising the tasks and maneuvers to the spacecraft for operation. Also, the ground station provider(s) can receive analytics and telemetry data from the spacecraft and/or ground station provider to pass on to the command and control manager 525. The data from the spacecraft can be provided from command and control manager 525 to mission plan manager 501 and other applications or computing devices downstream. For example, the data may indicate a missed capture or task by the spacecraft. Thus, command and control manager 525 can distribute the failed task to allow mission plan manager 501 to replan the task, and ultimately, reorganize the task queue.

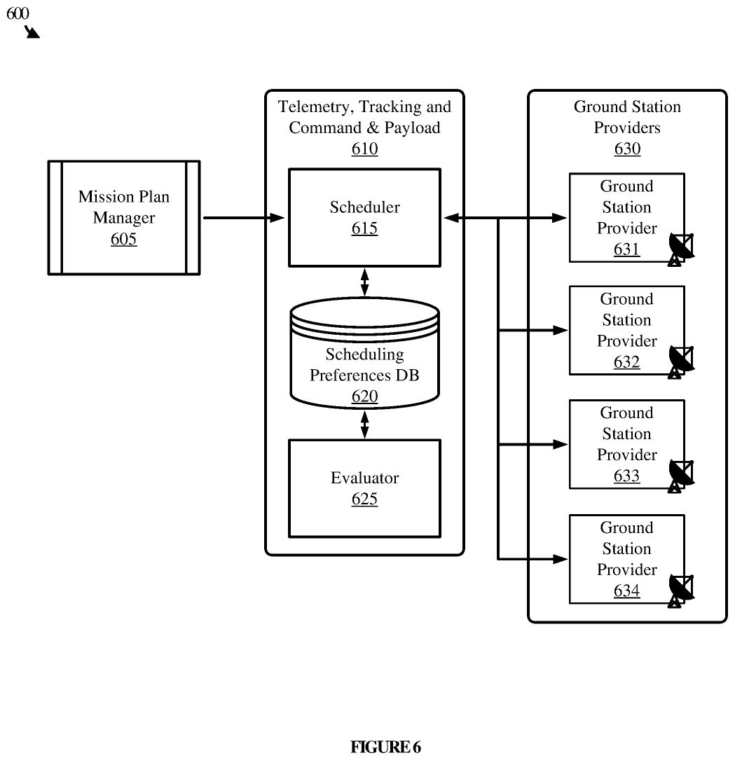

FIG. 6 illustrates an exemplary operating architecture of a scheduling orchestrator interfaced with ground station providers in which some embodiments of the present technology may be utilized. FIG. 6 includes operating architecture 600, which further includes mission plan manager 605, telemetry, tracking, and command & payload 610 (hereinafter referred to as TT&C 610), and ground station providers 630. TTC 610 comprises scheduler 615, scheduling preferences database 620, and evaluator 625. Ground station providers 630 collectively refers to and includes ground station providers 631, 632, 633, and 634. In various embodiments, mission plan manager 605 can execute processes 200 or 202 of FIG. 2.

In operation, mission plan manager 605 receives various inputs comprising information about a user, a spacecraft, ground station providers, and requests to be carried out by the spacecraft. As such, the mission plan manager 605 can plan and prioritize the requests according to the spacecraft's flight path, the spacecraft's power and processing capacity, and the ground station's availability, among other elements. After generating a mission plan, mission plan manager 505 can interface with TT&C 610 to implement the mission plan.

TT&C 610 comprises scheduler 615, scheduling preferences database 620, and evaluator 625. In various embodiments, scheduler 615 communicates with scheduling preferences database 620 to align the mission plan with user-defined preferences. For example, a user may request a preferred pass cadence, a number of tasks desired on each spacecraft pass, a collection resolution required, a preferred antenna and/or ground station provider, and the like. Additionally, scheduling preferences database 620 can communicate with evaluator 625 which can weigh the scheduling preferences, tasks, and available antennas to provide an evaluation of which ground station provider of ground station providers 630 to use for each task in the mission plan. For instance, evaluator 625 can use criteria to evaluate each available antenna such as antenna cost, antenna security, size, quality and resolution producible by the antenna, duration of contact with antenna, and similar metrics. Scheduling preferences database 620 may store evaluation details for future use.

Based at least on an evaluation by evaluator 625, an availability of ground station providers 630, and the prioritized mission plan from mission plan manager 605, among other factors, scheduler 615 can assign each task of the mission plan to a ground station provider. Then, scheduler 615 can communicate with each ground station provider being used via an API or other communication interface. Each ground station provider may utilize a different API, in which case scheduler 615 can modify its communication protocol accordingly to contact the ground station provider. Ground station providers 630 can then upload tasks from the mission plan to the spacecraft (not pictured).

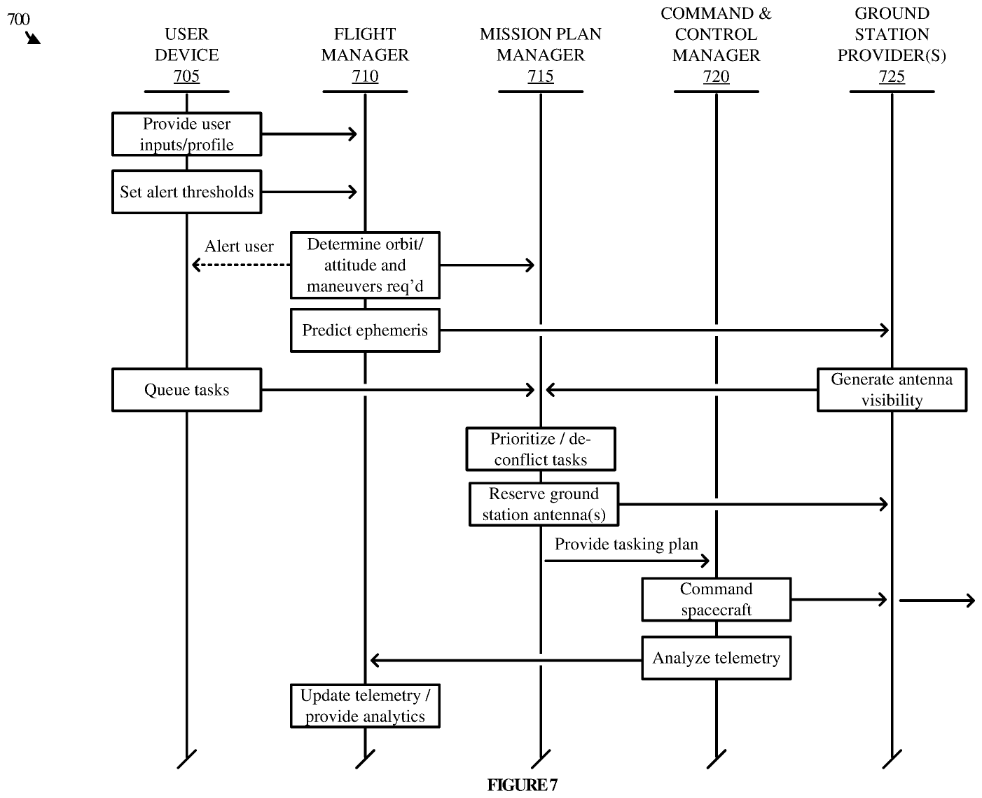

FIG. 7 is a sequence diagram illustrating data flow between various components of a spacecraft mission orchestration system in accordance with some embodiments of the present technology. FIG. 7 includes environment 700, which further includes user device 705, flight manager 710, mission plan manager 715, command and control manager 720, and ground station provider(s) 725. For example, environment 700 can embody operating architecture 100 of FIG. 1. Also, environment 700 can operate utilizing process 200 of FIG. 2.

First, user device 705 provides user inputs and profile information to flight manager 710. User inputs may include one or more tasks and/or maneuvers to be performed by a spacecraft. Profile information can include a user's name, spacecraft information, constraints, and telemetry, collection preferences, and the like. User device 705, can also set alert thresholds which define how, when, and what to be notified about during the spacecraft lifecycle. Examples include a threshold limit of the probability of a collision, a percentage of missing a task or maneuver, a deviation from orbit, and similar threats.

Flight manager 710 can use the user inputs to determine an orbit and attitude of the spacecraft. Flight manager 710 may not only be able to determine the current orbit of the spacecraft, but also it can propagate the spacecraft's orbit to provide a predictive ephemeris to ground station provider(s) 725. Flight manager 710 can also determine whether the spacecraft's current or future orbit coincide with any objects in space, and if so, it can provide maneuvers required to mission plan manager 715. Further, flight manager 710 may alert a user using user device 705 if the thresholds set by user device 705 are breached due to a possible coincidence.

Next, user device 705 can queue tasks for the spacecraft to complete. These tasks can comprise maneuvers, image or visual capture requests (i.e., SAR collection), downlink requests, or other requests. Based on the requested tasks and the predictive ephemeris, ground station provider(s) can generate antenna visibility. The antenna visibility provides windows of time, among other information, that an antenna can communicate with the spacecraft while in-orbit. Mission plan manager 715 obtains the queued tasks, prioritizes and de-conflicts the list of tasks. Mission plan manager 715 can prioritize the tasks based on several criteria. In an instance, the criteria can include comparing the cost of the tasks, source of the tasks, length of existence of the tasks, and the like. Then, mission plan manager 715 can provide the prioritized tasking plan to command and control manager 720. Based on a priority of tasks and the antenna visibility, mission plan manager 715 can reserve ground station antenna(s) for one or more windows of time depending on the duration of the task. Mission plan manager 715 can communicate with ground station provider(s) 725 to reserve one or more antennas via an API or another communication interface.

Command and control manager 720 can provide tasks to assigned antennas to command the spacecraft while in range of ground station provider(s) 725. In some embodiments, command and control manager 720 can transmit one or more tasks to one ground station provider 725, and subsequently, it can transmit other task(s) to a further ground station provider 725 based on the tasking plan and reservation information. Ground station provider(s) 725 relay the tasks to the spacecraft to perform data capture, maneuvers, and/or other tasks. Command and control manager 720 can then analyze telemetry and data from the spacecraft to determine an accuracy of the predictive ephemeris, quality of the data capture, onboard health and other spacecraft information. Command and control manager 720 can provide the analytics collected to flight manager 710 to update flight plans and maneuvers, if necessary.

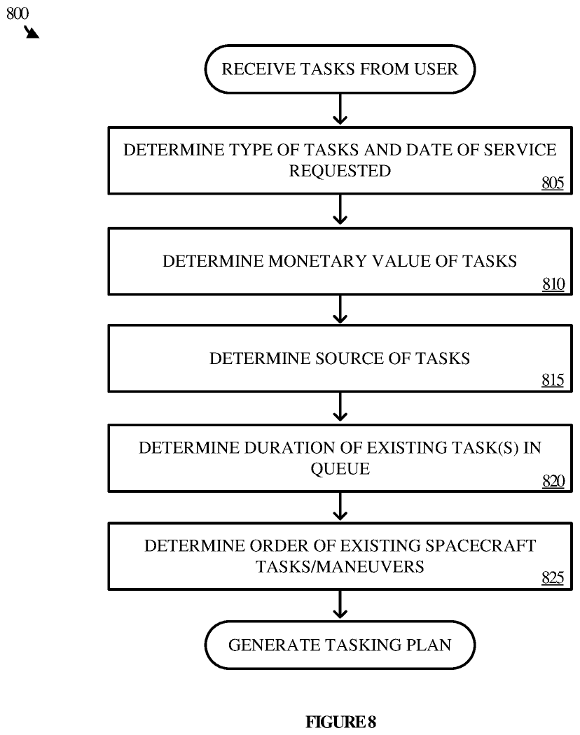

FIG. 8 is a flowchart illustrating a series of steps for prioritizing and deconflicting spacecraft mission tasks in accordance with some embodiments of the present technology. FIG. 8 includes process 800, which can be implemented on software, hardware, firmware, or any combination thereof. For example, a mission plan manager, like mission plan manager 103 of FIG. 1 can implement process 800 to create and/organize a tasking plan.

To begin, a mission plan manager or flight plan manager can receive tasks from a user. The tasks can comprise one or more maneuvers, data capture requests, or other spacecraft operations. In operation 805, a mission plan manager determines the type of tasks and date of service requested by the user. For example, a type could include a test or training task, an exercise, an emergency task, and the like. The date of service requested can include both the date and time that the task is added to a queue and a desired due date or timeframe of execution of the task.

In operation 810, the mission plan manager determines the monetary value of tasks in the queue. The monetary value may include the cost paid by the user for the task, the value provided by performing the task, and the like.

Next, in operation 815, the mission plan manager determines a source of the tasks. The source may be internal or external. An internal task can be one input from an internal user, automatically generated by the mission plan manager or flight plan manager, or some other internal source. An external task can be one input by an end-user, customer, ground station operation, or the like.

In operation 820, the mission plan manager determines the duration of existing task(s) in the task queue. The mission plan manager can use the date of service requested by the user (e.g., from operation 805) to evaluate timestamps from each task in the tasking plan. For example, an older task can have more weight than a newly added task. In other embodiments, a newer task may have more weight.

Lastly, in operation 825, the mission plan manager determines an order of existing spacecraft tasks and maneuvers. Existing maneuvers can impact the evaluation given conflicts. For example, a maneuver may be required in order to perform a task in the queue. Thus, existing maneuvers can take priority over tasks in the queue.

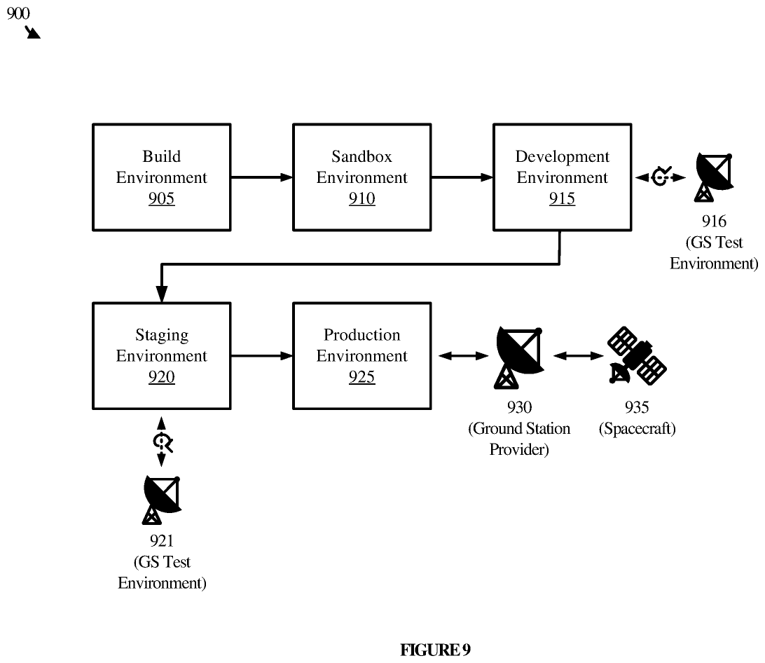

FIG. 9 illustrates an exemplary operating architecture of development and production environments which may be utilized in some embodiments of the present technology. FIG. 9 includes operating architecture 900, which further includes build environment 905, sandbox environment 910, development environment 915, ground station test environments 916 and 921, staging environment 920, production environment 925, ground station provider 930, and spacecraft 935.

Operating architecture 900 begins with environment 905. Build environment 905 embodies a virtual environment wherein a user can create custom interfaces and components representative of a real spacecraft management system. For example, a user can input a flight plan manager, a mission plan manager, a command and control plan manager, and/or other spacecraft communication and operation applications.

The components of build environment 905 can be replicated in sandbox environment 910 to perform testing on the system. Sandbox environment 910 can employ imaginary data to simulate or emulate tests on the various components imported from build environment 905.

Next, the components of both build environment 905 and sandbox environment 910 can be replicated in development environment 915. Development environment 915 can provide further data and testing for each component and the system as a whole. In development environment 915, a user can perform integration testing on the mission and flight planning system along with its virtual interface with a simulated spacecraft and ground station test environment 916. During integration testing, each interface between components, the simulated spacecraft, and the ground station test environment 916 can be iteratively tested.

Following development environment 915, staging environment 920 can provide a higher fidelity testing environment with each component from the preceding test environments. In staging environment 920, a user can perform system testing on the mission and flight planning system along with its virtual interface with a spacecraft (e.g., a flatsat spacecraft) and ground station test environment 921. Staging environment 920 may provide the highest fidelity of testing prior to a real implementation of the system.

Production environment 925 represents a real implementation of a mission and flight planning system that is configured to communicate with a ground station provider 930 in real-time. Production environment 925 can receive inputs from a user comprising tasks and maneuvers for the spacecraft. Production environment 925 can also receive real telemetry from a spacecraft 935 to plot its current orbit and predict a future orbit, as a two-line element. The components of production environment 925 can then generate a mission plan comprised of prioritized tasks and maneuvers based on availability provided by ground station provider 930. The system can then reserve availability of ground station provider 930. Ground station provider 930 can use the tasking plan to command the spacecraft 935.

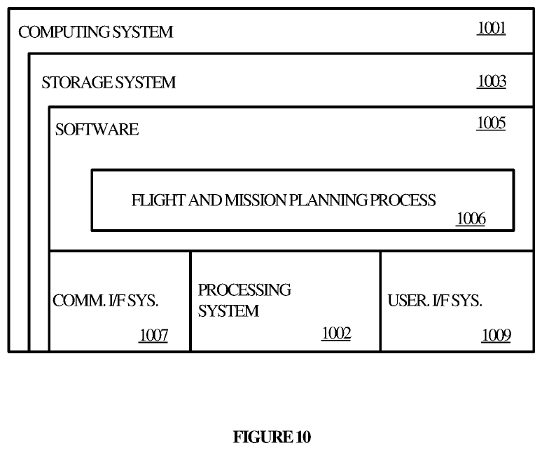

FIG. 10 illustrates computing system 1001 to perform flight and mission planning according to an implementation of the present technology. Computing system 1001 is representative of any system or collection of systems with which the various operational architectures, processes, scenarios, and sequences disclosed herein for flight and mission planning may be employed. Computing system 1001 may be implemented as a single apparatus, system, or device or may be implemented in a distributed manner as multiple apparatuses, systems, or devices. Computing system 1001 includes, but is not limited to, processing system 1002, storage system 1003, software 1005, communication interface system 1007, and user interface system 1009 (optional). Processing system 1002 is operatively coupled with storage system 1003, communication interface system 1007, and user interface system 1009.

Processing system 1002 loads and executes software 1005 from storage system 1003. Software 1005 includes and implements flight and mission planning process 1006, which is representative of any of the flight and mission planning processes discussed with respect to the preceding Figures. When executed by processing system 1002 to provide flight and mission planning functions, software 1005 directs processing system 1002 to operate as described herein for at least the various processes, operational scenarios, and sequences discussed in the foregoing implementations. Computing system 1001 may optionally include additional devices, features, or functionality not discussed for purposes of brevity.

Referring still to FIG. 10, processing system 1002 may comprise a micro-processor and other circuitry that retrieves and executes software 1005 from storage system 1003. Processing system 1002 may be implemented within a single processing device but may also be distributed across multiple processing devices or sub-systems that cooperate in executing program instructions. Examples of processing system 1002 include general purpose central processing units, graphical processing units, application specific processors, and logic devices, as well as any other type of processing device, combinations, or variations thereof.

Storage system 1003 may comprise any computer readable storage media readable by processing system 1002 and capable of storing software 1005. Storage system 1003 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1003 may also include computer readable communication media over which at least some of software 1005 may be communicated internally or externally. Storage system 1003 may be implemented as a single storage device but may also be implemented across multiple storage devices or sub-systems co-located or distributed relative to each other. Storage system 1003 may comprise additional elements, such as a controller, capable of communicating with processing system 1002 or possibly other systems.

Software 1005 (including flight and mission planning process 1006) may be implemented in program instructions and among other functions may, when executed by processing system 1002, direct processing system 1002 to operate as described with respect to the various operational scenarios, sequences, and processes illustrated herein. For example, software 1005 may include program instructions for implementing an embedded analytic engine for motor drives system as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1005 may include additional processes, programs, or components, such as operating system software, virtualization software, or other application software. Software 1005 may also comprise firmware or some other form of machine-readable processing instructions executable by processing system 1002.

In general, software 1005 may, when loaded into processing system 1002 and executed, transform a suitable apparatus, system, or device (of which computing system 1001 is representative) overall from a general-purpose computing system into a special-purpose computing system customized to provide flight and mission planning as described herein. Indeed, encoding software 1005 on storage system 1003 may transform the physical structure of storage system 1003. The specific transformation of the physical structure may depend on various factors in different implementations of this description. Examples of such factors may include, but are not limited to, the technology used to implement the storage media of storage system 1003 and whether the computer-storage media are characterized as primary or secondary storage, as well as other factors.

For example, if the computer readable storage media are implemented as semiconductor-based memory, software 1005 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1007 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1001 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for,” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

1. A method of operating a spacecraft mission manager, the method comprising:
obtaining user inputs for a spacecraft mission, wherein the user inputs comprise at least a synthetic aperture radar request of a target area, one or more maneuvers for a spacecraft to reach the target area, and a mission profile including a desired mission management style;
determining an orbit path of the spacecraft based at least on the user inputs and telemetry of the spacecraft;
obtaining a visibility schedule of one or more antennas from one or more ground station providers corresponding to the orbit path of the spacecraft;
generating a tasking plan to perform the user inputs for the spacecraft mission based at least on the visibility schedule; and
providing the tasking plan to at least one ground station provider of the one or more ground station providers.

2. The method of claim 1, further comprising providing a notification of a breach of a threshold based at least on a conjunction between the spacecraft and an object in the orbit path.

3. The method of claim 1, further comprising determining a failure in the tasking plan and, responsive to determining the failure, generating an updated tasking plan to perform failed user inputs for the spacecraft mission.

4. The method of claim 1, wherein providing the tasking plan to the at least one ground station provider of the one or more ground station providers comprises communicating via one or more application programming interfaces.

5. The method of claim 1, wherein generating the tasking plan comprises prioritizing the user inputs based on a source of the user inputs, a cost associated with the user inputs, and a duration of existence of the user inputs in a queue.

6. The method of claim 1, wherein the desired mission management style indicates a pass cadence with which to perform the user inputs.

7. The method of claim 6, wherein:
the mission profile further includes one or more spacecraft constraints, and
the one or more spacecraft constraints include at least a processing capacity, a technological capacity, and a power capacity of the spacecraft.

8. A computing apparatus, comprising:
one or more computer-readable storage media; and
program instructions stored on the one or more computer-readable storage media that, based on being read and executed by a processing system, direct a spacecraft mission manager to at least:
obtain user inputs for a spacecraft mission, wherein the user inputs comprise at least a synthetic aperture radar request of a target area, one or more maneuvers for a spacecraft to reach the target area, and a mission profile including a desired mission management style;
determine an orbit path of the spacecraft based at least on the user inputs and telemetry of the spacecraft;
obtain a visibility schedule of one or more antennas from one or more ground station providers corresponding to the orbit path of the spacecraft;
generate a tasking plan to perform the user inputs for the spacecraft mission based at least on the visibility schedule; and
provide the tasking plan to at least one ground station provider of the one or more ground station providers.

9. The computing apparatus of claim 8, wherein the program instructions further direct the spacecraft mission manager to provide a notification of a breach of a threshold based at least on a conjunction between the spacecraft and an object in the orbit path.

10. The computing apparatus of claim 8, wherein the program instructions further direct the spacecraft mission manager to determine a failure in the tasking plan and, responsive to determining the failure, generate an updated tasking plan to perform failed user inputs for the spacecraft mission.

11. The computing apparatus of claim 8, wherein to provide the tasking plan to the at least one ground station provider of the one or more ground station providers, the program instructions direct the spacecraft mission manager to communicate via one or more application programming interfaces.

12. The computing apparatus of claim 8, wherein to generate the tasking plan, the program instructions direct the spacecraft mission manager to prioritize the user inputs based on a source of the user inputs, a cost associated with the user inputs, and a duration of existence of the user inputs in a queue.

13. The computing apparatus of claim 8, wherein the desired mission management style indicates a pass cadence with which to perform the user inputs.

14. The computing apparatus of claim 8, wherein:
the mission profile further includes one or more spacecraft constraints, and
the one or more spacecraft constraints include at least a processing capacity, a technological capacity, and a power capacity of the spacecraft.

15. A method of operating a spacecraft mission manager, the method comprising:
obtaining a collection request comprising one or more tasks for a spacecraft to perform synthetic aperture radar capture of a target area, one or more maneuvers for the spacecraft to reach the target area, and a mission profile including a desired mission management style;
obtaining a visibility schedule of one or more ground station providers, wherein the visibility schedule provides one or more timeframes of availability of at least one ground station provider of the one or more ground station providers based at least on the collection request and telemetry of the spacecraft;
prioritizing the one of more tasks based at least on conflict criteria and the visibility schedule of the one or more ground station providers; and
generating a spacecraft mission plan based at least on the prioritized one or more tasks.

16. The method of claim 15, further comprising reserving the one or more timeframes of availability of the at least one ground station provider of the one or more ground station providers.

17. The method of claim 16, wherein reserving the one or more timeframes of availability comprises communicating with the at least one ground station provider of the one or more ground station providers via an application programming interface.

18. The method of claim 15, wherein the conflict criteria include at least one among a cost of the one or more tasks, a source of the one or more tasks, an importance of the one or more tasks, and a date requested of the one or more tasks.

19. The method of claim 15, wherein prioritizing the one or more tasks comprises evaluating the visibility schedule based at least one among a usage cost of the one or more ground station providers, a quality of the one or more ground station providers, and the one or more timeframes of availability of the one or more ground station providers.

20. The method of claim 15, wherein the desired mission management style indicates a pass cadence with which to perform the user inputs.

21. A method of operating a spacecraft flight manager, the method comprising:
identifying a collection request associated with a spacecraft, wherein the collection request comprises one or more tasks for the spacecraft to perform synthetic aperture radar capture of a target area, one or more maneuvers for the spacecraft to reach the target area, and a mission profile including a desired mission management style of the collection request;
obtaining telemetry of the spacecraft to determine an orbit path of the spacecraft;
obtaining a conjunction assessment corresponding to the orbit path of the spacecraft, wherein the conjunction assessment provides telemetry of objects in the orbit path;
setting one or more thresholds corresponding to the conjunction assessment and the orbit path of the spacecraft; and
responsive to a breach of at least one threshold of the one or more thresholds, providing a notification of the breach.

22. The method of claim 21, further comprising, responsive to the breach of the at least one threshold, commanding one or more maneuvers to correct the breach.

23. The method of claim 21, further comprising obtaining a visibility schedule of one or more ground station providers based at least on the orbit path of the spacecraft, wherein the visibility schedule indicates at least a timeframe and a position in the orbit path allowable for the one or more ground station providers to communicate with the spacecraft.

24. The method of claim 21, further comprising commanding one or more maneuvers to reach the position in the orbit path.

25. The method of claim 21, wherein the telemetry of the spacecraft comprises global position system data.

26. The method of claim 21, wherein the one or more thresholds are at least one among a distance between an object and the spacecraft and a distance between the spacecraft and the orbit path.

27. The method of claim 21, wherein the conjunction assessment further provides an indication of a collision based on the telemetry of the spacecraft and the telemetry of the objects in the orbit path.

28. A computing apparatus, comprising:
one or more computer-readable storage media; and
program instructions stored on the one or more computer-readable storage media that, based on being read and executed by a processing system, direct a spacecraft flight manager to at least:
identifying a collection request associated with a spacecraft, wherein the collection request comprises one or more tasks for the spacecraft to perform synthetic aperture radar capture of a target area, one or more maneuvers for the spacecraft to reach the target area, and a mission profile including a desired mission management style of the collection request;
obtain telemetry of the spacecraft to determine an orbit path of the spacecraft;
obtain a conjunction assessment corresponding to the orbit path of the spacecraft, wherein the conjunction assessment provides telemetry of objects in the orbit path;
set one or more thresholds corresponding to the conjunction assessment and the orbit path of the spacecraft; and
responsive to a breach of at least one threshold of the one or more thresholds, provide a notification of the breach.

29. The computing apparatus of claim 28, wherein responsive to the breach of the at least one threshold, the program instructions further direct the spacecraft flight manager to command one or more maneuvers to correct the breach.

30. The computing apparatus of claim 28, wherein the program instructions further direct the spacecraft flight manager to obtain a visibility schedule of one or more ground station providers based at least on the orbit path of the spacecraft, wherein the visibility schedule indicates at least a timeframe and a position in the orbit path allowable for the one or more ground station providers to communicate with the spacecraft.

31. The computing apparatus of claim 30, wherein the program instructions further direct the spacecraft flight manager to command one or more maneuvers to reach the position in the orbit path.

32. The computing apparatus of claim 28, wherein the telemetry of the spacecraft comprises global position system data.

33. The computing apparatus of claim 28, wherein the one or more thresholds are at least one among a distance between an object and the spacecraft and a distance between the spacecraft and the orbit path.

34. The computing apparatus of claim 28, wherein the conjunction assessment further provides an indication of a collision based on the telemetry of the spacecraft and the telemetry of the objects in the orbit path.

35. One or more computer-readable storage media having program instructions stored thereon to operate a spacecraft mission orchestration engine, wherein the program instructions, when read and executed by a processing system, direct the processing system to at least:
obtain user inputs for a spacecraft mission, wherein the user inputs comprise at least a synthetic aperture radar request of a target area, one or more maneuvers for a spacecraft to reach the target area, and a mission profile including a desired mission management style;
determine an orbit path of the spacecraft based at least on the user inputs and telemetry of the spacecraft;
obtain a visibility schedule of one or more antennas from one or more ground station providers corresponding to the orbit path of the spacecraft;
generate a tasking plan to perform the user inputs for the spacecraft mission based at least on the visibility schedule; and
provide the tasking plan to at least one ground station provider of the one or more ground station providers.

36. The one or more computer-readable storage media of claim 35, wherein the program instructions further direct the processing system to provide a notification of a breach of a threshold based at least on a conjunction between the spacecraft and an object in the orbit path.

37. The one or more computer-readable storage media of claim 35, wherein the program instructions further direct the processing system to determine a failure in the tasking plan and, responsive to determining the failure, generate an updated tasking plan to perform failed user inputs for the spacecraft mission.

38. The one or more computer-readable storage media of claim 35, wherein to provide the tasking plan to the at least one ground station provider of the one or more ground station providers, the program instructions further direct the processing system to communicate via one or more application programming interfaces.

39. The one or more computer-readable storage media of claim 35, wherein to generate the tasking plan, the program instructions further direct the processing system to prioritize the user inputs based on at least one among a source of the user inputs, a cost of the user inputs, a date requested, and a type of the user inputs.

40. The one or more computer-readable storage media of claim 35, wherein the desired mission management style indicates a pass cadence with which to perform the user inputs.
